(19) United States
(12) Patent Application Publication
(10) Pub. No.: US 2026/0146529 A1
(43) Pub. Date: May 28, 2026

(54) WIRELESS SHORT HOP AT BOTTOM HOLE ASSEMBLY WITH OPTIMIZED TRANSMISSION STABILITY

(71) Applicant: Gordon Technologies LLC, Scott, LA (US)

(72) Inventors: Benjamin G. Frith, Lafayette, LA (US); John J. Daigle, Lafayette, LA (US); Ira Shankar, Sugar Land, TX (US); Terrence G. Frith, Lafayette, LA (US)

(21) Appl. No.: 19/453,786

(22) Filed: Jan. 20, 2026

Related U.S. Application Data
(63) Continuation of application No. PCT/US2025/039740, filed on Jul. 29, 2025.
(60) Provisional application No. 63/677,404, filed on Jul. 30, 2024.
(60) Provisional application No. 63/726,518, filed on Nov. 30, 2024.

(51) Int. Cl. E21B 47/13; E21B 47/017

(52) U.S. Cl. CPC E21B 47/13; E21B 47/017

(57) ABSTRACT

A wireless short hop assembly includes a transmitter antenna and an integrated receiver/pulser module. A receiver antenna and a pulser assembly are consolidated into the receiver/pulser module. The transmitter antenna is configured to transmit, via magnetic flux induction, a magnetic carrier wave conveying a wireless signal to the receiver antenna. When the wireless short hop assembly is deployed on subterranean drilling bottom hole assembly (BHA) such that a shock reduction tool is interposed on the BHA between the transmitter antenna and the integrated receiver/pulser module, the integrated receiver/pulser module positions the receiver antenna closer to the shock reduction tool and the transmitter antenna than if the receiver antenna and the pulser assembly were discrete. The wireless signal as received by the receiver antenna is stronger and more stable than if the receiver antenna and the pulser assembly were discrete.

### RELATED APPLICATIONS AND PRIORITY CLAIMS

This application is a continuation application claiming benefit under 35 U.S.C. § 365, and priority to, co-pending and commonly-invented International Application No. PCT/US25/39740 filed Jul. 29, 2025, which designates the U.S., and which further claims the benefit of, and priority to, the following two commonly-invented U.S. Provisional Patent Applications: (1) U.S. Provisional Patent Application Ser. No. 63/677,404 filed Jul. 30, 2024; and (2) U.S. Provisional Patent Application Ser. No. 63/726,518 filed Nov. 30, 2024. The entire disclosures of PCT/US25/39740, 63/677,404 and 63/726,518 are incorporated herein by reference.

### FIELD OF THE DISCLOSURE

This disclosure is directed generally to subterranean drilling technology, and more specifically to wireless data telemetry. In disclosed embodiments, a wireless short hop assembly is configured in the bottom hole assembly (“BHA”) to improve the stability of wireless data transmissions over the short hop.

### BACKGROUND

As is well known, sensors such as logging while drilling (LWD) sensors or measurement while drilling (MWD) sensors (“Remote Data Sources” or RDS) gather data of interest in or around the BHA for telemetry to the surface. Mud pulse telemetry is often used to carry the data of interest to the surface. A mud pulser assembly (or “pulser assembly”) telemeters the data modulated onto sonic mud pulses. The pulser assembly is often deployed in conjunction with a shock reduction tool and a UBHO (Universal Bottom Hole Orientation) sub. Some conventional BHA deployments may position the pulser assembly uphole of resistivity tools and other RDS sensors, requiring the sensor data initially to travel uphole from the RDS sensors to the pulser assembly.

In other known deployments, a Rotary Steerable System (RSS) is advantageously positioned in the BHA near the bit in order to optimize steering performance. Refer to FIG. 1A, described in greater detail below. Data communications (such as measurements or instructions) between the surface and RSS may primarily be via mud pulse telemetry. A mud pulser assembly is typically positioned uphole of the RSS to allow the RSS to reside closer to the bit. The data communications must then travel between the pulser assembly and the RSS.

Some sections of the BHA may present challenges to conventional data transfer between the RDS sensors or the RSS and the pulser assembly. Such problematic BHA sections may include a UBHO and/or a shock reduction tool. The physical constructions of these BHA sections discourage conventional hard wiring through the tool to enable data transfer between the downhole RDS sensors or RSS and the uphole pulser assembly. Some conventional BHA deployments provide a so-called “wireless short hop” assembly to transmit data around or over a section of the BHA presenting such data transfer challenges. Refer again to FIG. 1A, this time in conjunction with FIG. 1B. The wireless short hop assembly typically provides a downhole transmitter module and an uphole receiver module. A wireless transmission carries encoded data of interest (e.g., RDS or RSS data) from transmitter module to receiver module. The transmission “hops” over the section(s) of the BHA presenting data transfer challenges. In such deployments, the receiver module is typically located at or near the pulser assembly, although the receiver module and pulser assembly are discrete. A receiver antenna within the receiver module may receive the wireless transmission with data of interest encoded thereon. A receiver board within the receiver module may then decode the data of interest from the wireless transmission and transfer the data to the pulser assembly for mud pulse telemetry to the surface.

Conventional wireless short hop deployments are known to present data transmission challenges. A first challenge is to the strength of the signal received by the receiver module. Generally speaking, the quality and stability of the data transmission offered by a wireless short hop assembly may be predicted to improve with increased signal to noise ratio (SNR) in the transmission. Data transmission rates will generally tend to improve and data packet losses or corruptions in the transmission will generally tend to be fewer when the wireless carrier wave has a higher SNR. Generally speaking, positioning the receiver closer to the transmitter will tend to increase the SNR.

Positioning a wireless short hop receiver closer to the transmitter in a BHA presents its own challenges. Downhole BHA configurations are typically crowded with tools, sensors, instruments and other hardware competing for optimum space and location for their own individual performances. In some conventional BHA deployments, a BHA configuration that positions the wireless short hop receiver about 13.9 feet downhole from the transmitter has proven somewhat serviceable for data transmission. Such a conventional BHA configuration also allows other BHA equipment to function effectively. It will nonetheless be understood that such a conventional BHA deployment is only an illustrative example of the prior art on which wireless short hop embodiments described in this disclosure seek to improve.

Technical advantages may therefore be available in BHA reconfigurations where the wireless short hop receiver can be positioned closer to the transmitter. Signal to noise ratio should increase, potentially improving data transmission rates and potentially decreasing data packet losses in transmission, for example. As noted, however, BHA reconfigurations towards this goal can be elusive, particularly given (a) the volume of bottom hole equipment that must be housed within or around the BHA, and/or (b) the positional needs (relative or global) of individual pieces of equipment. Further, the concept of reducing the distance between wireless short hop receiver and transmitter is not always straightforward in and of itself. The receiver is commonly positioned near the pulser assembly, towards the uphole end of the BHA. In contrast, the transmitter is optimally positioned close to data-collecting sensors or an RSS, and typically such sensors are located at or near the downhole end of the BHA. Thus, merely reducing the distance between receiver and transmitter within the BHA, without more, can create positioning problems for the receiver or the transmitter (or both) by moving either the receiver away from the pulser assembly or the transmitter away from an RSS (or away from near-bit sensors). Further, merely reducing the distance between receiver and transmitter may cause an overall reduction in length of the BHA itself. A shorter BHA may become too small to accommodate the inventory of bottom hole equipment required to be housed and individually positioned within the BHA.

There is therefore a need in the art for a reconfigured BHA in which a wireless short hop assembly can gain potentially higher SNR (and associated data transmission benefits) from positioning the receiver closer to the transmitter. In embodiments, the BHA itself may also be reduced in length. In this way, BHA may reflect a reduced receiver-transmitter distance, even though the receiver is positioned at or near the uphole end of the BHA and the transmitter continues to be positioned at or near the downhole end of the BHA.

A second challenge to short hop wireless transmissibility is to the stability of the wireless transmission. Short hop wireless transmissibility can be destabilized by a number of drilling environment conditions. For example, wireless transmissibility may be affected by various types of background noise associated with the subterranean drilling process, including shock and vibration. Such background noise destabilizes magnetic flux in the magnetic auras and fields through which the short hop wireless transmission may be travel. Such background noise may also induce physical vibration in the receiver antenna, leading to further destabilization of the short hop wireless transmission as it is received by the receiver antenna. The generation of mud pulses during mud pulse telemetry may also induce physical vibration in the receiver antenna, causing further destabilization of the short hop wireless transmission as it is received by the receiver antenna. Conversely, a stable wireless data transmission will generally be expected to embody a steady, consistent (or unfluctuating) flow of encoded data from the transmitter to the receiver. In wireless short hop deployments, a stable wireless data transmission generally manifests itself as a flow of encoded data where data packet losses or corruptions are minimized or avoided.

Shock reduction tools are well known in BHA configurations using mud pulse telemetry. Shock reduction tools (or “SRTs”) are deployed to denoise waveforms traveling in a stabilizing field around the SRT. SRTs are configured to dampen background noise (such as shock and vibration) in the stabilizing field. The SRT is optimally positioned close to the pulser assembly, and may be integral with the pulser assembly in some deployments. In this way, the SRT's stabilizing field is configured to include the pulser assembly, and thereby stabilizes the data-encoded sonic waveforms (mud pulses) generated by the pulser assembly. The SRT thus enables a more stable flow of encoded mud pulses to be transmitted to the surface. In some embodiments, SRTs dampen in a bandwidth of +/−25 Hz.

There is a further need in the art for a reconfigured BHA that repositions a wireless short hop's receiver module to bring the receiver antenna more within an SRT's stabilizing field. Preferably, in BHA deployments including an SRT, the reconfigured BHA will position the short hop receiver antenna closer to the SRT (and thereby more within the SRT's stabilizing field). In this way, the SRT may stabilize a short hop's wireless transmission analogous to the manner in which the SRT stabilizes mud pulses generated by the pulser assembly.

### SUMMARY OF THE DISCLOSED TECHNOLOGY

This disclosure describes embodiments of an improved wireless short hop assembly in which the receiver module is consolidated with the pulser assembly into an integrated receiver/pulser module. In embodiments, the integrated receiver/pulser module includes a unitary housing for the consolidated receiver and pulser components. Integrated receiver/pulser modules as described in this disclosure thus improve on conventional wireless short hop deployments in which the receiver module and the pulser assembly are discrete, concatenated modules typically each having their own separate housings. The integrated receiver/pulser module is shorter in length than in corresponding prior art arrangements deployed as discrete, concatenated modules.

In embodiments, the integrated receiver/pulser module further obviates one or more snubber and electrical connections between a discrete receiver module and pulser assembly (as typically found in the prior art). Such integrated receiver/pulser module embodiments may be even shorter in length than in corresponding prior counterparts deployed as discrete modules.

In embodiments, the integrated receiver/pulser module further provides a customized snubber and electrical connection at an uphole end thereof, in which a shared wiring harness serves both the receiver and pulser components inside the unitary housing. This is in distinction to some corresponding prior art deployments in which the receiver module's components are served electrically by a different wiring harness than the pulser assembly's components.

A shorter, integrated receiver/pulser module consistent with embodiments described in this disclosure may thus be deployed in a BHA as a substitute, for example, for a conventional concatenation of a discrete receiver module and pulser assembly. The shorter, integrated receiver/pulser module thereby becomes available to reduce the overall transmission distance between the transmitter and the receiver as compared to that which may be found in conventional deployments of a wireless short hop assembly. The shorter transmission distance tends to increase the signal to noise ratio (SNR) in the transmission, which in turn tends to improve the quality and stability of the data transmission offered by the wireless short hop.

Further, in BHA configurations including a shock reduction tool (SRT), an integrated receiver/pulser module consistent with embodiments described in this disclosure positions the receiver antenna more within the stabilizing field of view of the SRT. That is, a shorter, integrated receiver/pulser module positioned nearby the SRT allows the receiver antenna to move closer overall to the SRT (and therefore more within the SRT's stabilizing field). The denoising effect of the SRT on waveforms in the SRT's stabilizing field becomes increasingly operable to stabilize the short hop's wireless transmissions, leading to fewer data packet losses, packet errors or packet corruptions. Further, a shorter, integrated receiver/pulser module positioned closer to the SRT allows the SRT to steady the receiver antenna against vibrations induced in the antenna by background shock and vibration and by the pulser assembly generating mud pulses.

An integrated receiver/pulser module also has a greater overall mass than a discrete receiver module by itself (as may be found in the prior art). The greater overall mass of the integrated receiver/pulser module tends to further attenuate background shock and vibration noise around the receiver components within the module. The greater overall mass of the module may thus further stabilize wireless transmissions by adding to the dampening and quieting effect of a nearby SRT.

According to a first aspect, therefore, this disclosure describes embodiments of a wireless short hop assembly, comprising: a transmitter antenna; and an integrated receiver/pulser module into which a receiver antenna and a pulser assembly are consolidated; wherein the transmitter antenna is configured to transmit a wireless signal to the receiver antenna; wherein, when the wireless short hop assembly is deployed on subterranean drilling bottom hole assembly (BHA) such that a shock reduction tool is interposed on the BHA between the transmitter antenna and the integrated receiver/pulser module, the integrated receiver/pulser module positions the receiver antenna closer to the shock reduction tool and the transmitter antenna than if the receiver antenna and the pulser assembly were discrete.

According to a second aspect, this disclosure describes embodiments of a wireless short hop assembly on a subterranean drilling bottom hole assembly, the wireless short hop assembly comprising: a transmitter antenna; and an integrated receiver/pulser module into which a receiver antenna and a pulser assembly are consolidated; wherein the transmitter antenna is configured to transmit a wireless signal to the receiver antenna; wherein a shock reduction tool is interposed on the bottom hole assembly between the transmitter antenna and the integrated receiver/pulser module; wherein the integrated receiver/pulser module positions the receiver antenna closer to the transmitter antenna than if the receiver antenna and the pulser assembly were discrete.

According to a third aspect, this disclosure describes embodiments of a wireless short hop assembly on a subterranean drilling bottom hole assembly, the wireless short hop assembly comprising: a transmitter antenna; and an integrated receiver/pulser module into which a receiver antenna and a pulser assembly are consolidated; wherein the transmitter antenna is configured to transmit a wireless signal to the receiver antenna; wherein a shock reduction tool is interposed on the bottom hole assembly between the transmitter antenna and the integrated receiver/pulser module; wherein the integrated receiver/pulser module positions the receiver antenna closer to the shock reduction tool and the transmitter antenna than if the receiver antenna and the pulser assembly were discrete.

In some embodiments according to the first, second or third aspects, the integrated receiver/pulser module consolidates the receiver antenna and pulser assembly into a unitary receiver/pulser module housing.

In some embodiments according to the first, second or third aspects, the integrated receiver/pulser module positions the receiver antenna at least about 2.4 feet closer to the transmitter antenna than if the receiver antenna and the pulser assembly were discrete.

In some embodiments according to the first, second or third aspects, the wireless signal is transmitted on a frequency of up to about 25 Hz.

In some embodiments according to the first, second or third aspects, the integrated receiver/pulser module has no snubber connections between the receiver antenna and the pulser assembly.

In some embodiments according to the first, second or third aspects, the integrated receiver/pulser module further includes a shared wiring harness serving both the receiver antenna and the pulser assembly.

According to a fourth aspect, this disclosure describes embodiments of a method for stabilizing a wireless transmission in a bottom hole assembly, the method comprising the steps of: providing a transmitter antenna, a receiver antenna, a pulser assembly and a shock reduction tool on a bottom hole assembly; interposing the pulser assembly and the shock reduction tool on the bottom hole assembly between the transmitter antenna and the receiver antenna; consolidating the receiver antenna and the pulser assembly into an integrated receiver/pulser module, such that the integrated receiver/pulser module positions the receiver antenna closer to the transmitter antenna than if the receiver antenna and the pulser assembly were discrete; transmitting a wireless signal from the transmitter antenna; and receiving the wireless signal at the receiver antenna, wherein the wireless signal as received by the receiver antenna travels a shorter distance than if the receiver antenna and the pulser assembly were discrete.

According to a fifth aspect, this disclosure describes embodiments of a method for stabilizing a wireless transmission in a bottom hole assembly, the method comprising the steps of: providing a transmitter antenna, a receiver antenna, a pulser assembly and a shock reduction tool on a bottom hole assembly; interposing the pulser assembly and the shock reduction tool on the bottom hole assembly between the transmitter antenna and the receiver antenna; causing the shock reduction tool to create a stabilizing field, wherein the stabilizing field denoises waveforms traveling through the stabilizing field; consolidating the receiver antenna and the pulser assembly into an integrated receiver/pulser module, such that the integrated receiver/pulser module positions the receiver antenna closer to the shock reduction tool and the transmitter antenna than if the receiver antenna and the pulser assembly were discrete; transmitting a wireless signal from the transmitter antenna; and receiving the wireless signal at the receiver antenna, wherein the wireless signal as received by the receiver antenna travels a shorter distance than if the receiver antenna and the pulser assembly were discrete, wherein further the wireless signal travels more within the stabilizing field than if the receiver antenna and the pulser assembly were discrete.

In some embodiments according to the fourth or fifth aspects, the receiver antenna and pulser assembly are consolidated into a unitary receiver/pulser module housing.

In some embodiments according to the fourth or fifth aspects, the integrated receiver/pulser module positions the receiver antenna at least about 2.4 feet closer to the transmitter antenna than if the receiver antenna and the pulser assembly were discrete.

In some embodiments according to the fourth or fifth aspects, the wireless signal is transmitted on a frequency of up to about 25 Hz.

In some embodiments according to the fourth or fifth aspects, the integrated receiver/pulser module has no snubber connections between the receiver antenna and the pulser assembly.

In some embodiments according to the fourth or fifth aspects, the integrated receiver/pulser module further includes a shared wiring harness serving both the receiver antenna and the pulser assembly.

The foregoing has rather broadly outlined some features and technical advantages of the disclosed wireless short hop technology, in order that the following detailed description may be better understood. Additional features and advantages of the disclosed technology may be described. It should be appreciated by those skilled in the art that the conception and the specific embodiments disclosed may be readily utilized as a basis for modifying or designing other structures for carrying out the same inventive purposes of the disclosed technology, and that these equivalent constructions do not depart from the spirit and scope of the technology as described.

### BRIEF DESCRIPTION OF THE DRAWINGS

For a more complete understanding of the embodiments described in this disclosure, and their advantages, reference is made to the following detailed description taken in conjunction with the accompanying drawings, in which:

FIG. 1A is a block drawing illustrating schematically a first prior art wireless short hop arrangement, deployed in conjunction with a Rotary Steerable System (RSS);

FIG. 1B is a block drawing illustrating schematically a prior art embodiment of BHA components per FIG. 1A, including a conventional wireless short hop assembly 10 providing a discrete receiver antenna 53 and pulser assembly 40;

FIG. 1C is a block drawing illustrating schematically an embodiment of BHA components consistent with improvements described in this disclosure, including an improved wireless short hop assembly 100 providing an integrated receiver/pulser module 150;

FIG. 2A illustrates an embodiment of an improved wireless short hop assembly 100 consistent with this disclosure;

FIG. 2B is a section of uphole portion 115 as shown on FIG. 2A;

FIG. 2C is a section of downhole portion 116 as shown on FIG. 2A;

FIG. 2D is an exploded view of the embodiment of improved wireless short hop assembly 100 depicted on FIG. 2A;

FIGS. 3, 3A, 3B and 3C are prior art graphs plotting values measured during a first drilling job (“JOB A”) for transmitted signal parameters in a wireless short hop deployment, in which the receiver module and the pulser assembly were deployed as discrete, concatenated assemblies in the style of receiver module 50 and pulser assembly 40 on FIGS. 1A and 1B, and in which further:

FIG. 3 is a combination overlay plot 300 of FIGS. 3A, 3B and 3C;

FIG. 3A plots transmitted signal strength by itself over time;

FIG. 3B plots data transmission error status code by itself over time; and

FIG. 3C plots drilling fluid flow status code by itself over time;

FIGS. 4, 4A, 4B, 4C and 4D are prior art graphs plotting values measured during the first drilling job (“JOB A”) for shock and vibration parameters for a wireless short hop deployment, in which the receiver assembly and the pulser assembly were deployed as discrete, concatenated assemblies in the style of receiver module 50 and pulser assembly 40 on FIGS. 1A and 1B, and in which further:

FIG. 4 is a combination overlay plot 400 of FIGS. 4A, 4B, 4C and 4D;

FIG. 4A plots lateral peak shock by itself over time;

FIG. 4B plots lateral vibration by itself over time;

FIG. 4C plots axial peak shock by itself over time; and

FIG. 4D plots axial vibration by itself over time;

FIGS. 5, 5A, 5B and 5C are graphs plotting values measured during a second drilling job (“JOB B”) for transmitted signal parameters in a wireless short hop deployment, in which the receiver module and the pulser assembly were consolidated into a receiver/pulser module in the style of integrated receiver/pulser module 150 on FIGS. 1C and 2A through 2D, and in which further:

FIG. 5 is a combination overlay plot 500 of FIGS. 5A, 5B and 5C;

FIG. 5A plots transmitted signal strength by itself over time;

FIG. 5B plots data transmission error status code by itself over time; and

FIG. 5C plots drilling fluid flow status code by itself over time;

FIGS. 6, 6A, 6B, 6C and 6D are graphs plotting values measured during the second drilling job (“JOB B”) for shock and vibration parameters for a wireless short hop deployment in which the receiver module and the pulser assembly were consolidated into a receiver/pulser module in the style of integrated receiver/pulser module 150 on FIGS. 1C and 2A through 2D, and in which further:

FIG. 6 is a combination overlay plot 600 of FIGS. 6A, 6B, 6C and 6D;

FIG. 6A plots lateral peak shock by itself over time;

FIG. 6B plots lateral vibration by itself over time;

FIG. 6C plots axial peak shock by itself over time;

FIG. 6D plots axial vibration by itself over time;

FIG. 7A (prior art) is a rendition of FIG. 1B (prior art) showing schematically the influence of SRT stabilizing field 95 on conventional wireless short hop assembly 10; and

FIG. 7B is a rendition of FIG. 1C showing schematically the influence of SRT stabilizing field 195 on improved wireless short hop assembly 100.

### DETAILED DESCRIPTION

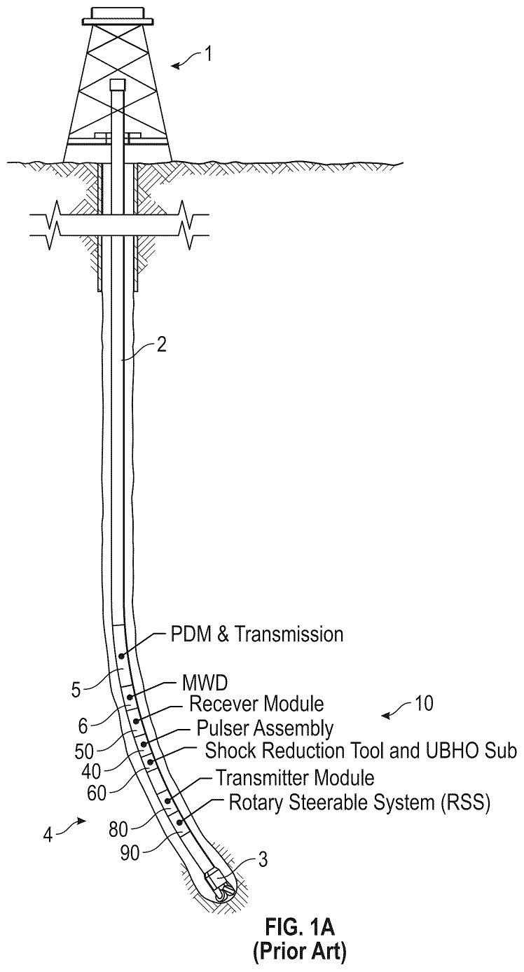

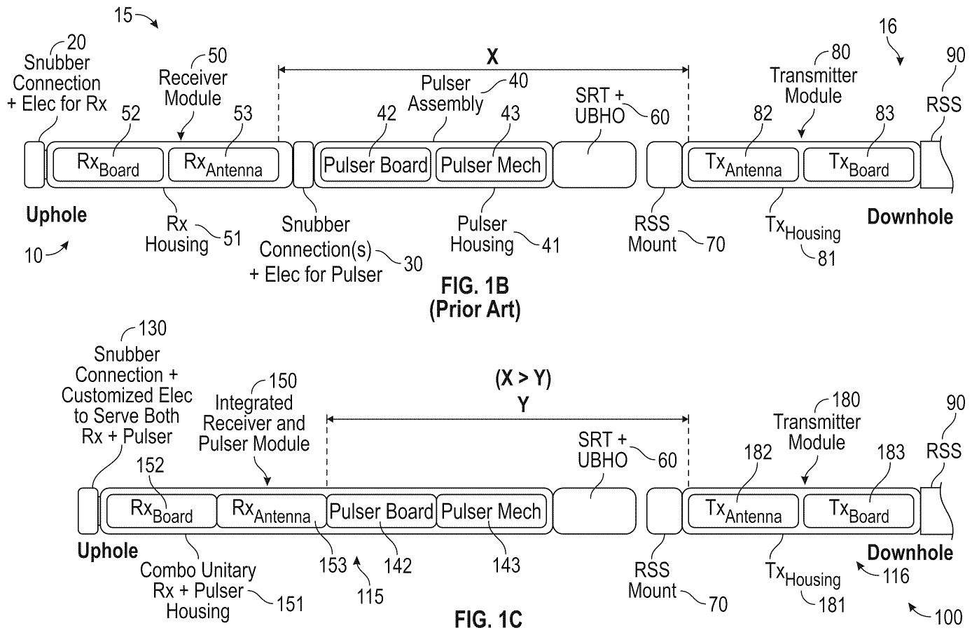

Reference is now made to FIGS. 1 through 7B in describing the currently preferred embodiments of the disclosed wireless short hop technology, and its related features. FIGS. 1 through 7B should be viewed as a whole for the purposes of the following disclosure. Any part, item, or feature that is identified by part number on one of FIGS. 1 through 7B will have the same part number when illustrated on another of FIGS. 1 through 7B. It will be understood that the embodiments as illustrated and described with respect to FIGS. 1 through 7B are exemplary, and the scope of the inventive material set forth in this disclosure is not limited to such illustrated and described embodiments.

FIGS. 1A and 1B are block drawings illustrating schematically a prior art (conventional) wireless short hop 10. Referring first to FIG. 1A, conventional wireless short hop assembly 10 is deployed in conjunction with a Rotary Steerable System (RSS) 90. FIG. 1A illustrates drilling operations from rig 1, to which bit 3 is connected via drillstring 2. The embodiment of FIG. 1A depicts a deviated wellbore in which bit 3 is driven by a positive displacement motor (PDM), or “mud motor”, and is steered by RSS 90. As described in the Background section above, RSS 90 in FIG. 1A is advantageously positioned near bit 3 in order to optimize steering performance. The scope of this disclosure is not limited, however, to drilling operations involving deviated wellbores or particular RSS or PDM deployments.

FIG. 1A further illustrates a section of interest 4 in the Bottom Hole Assembly (BHA). FIG. 1A depicts BHA section of interest 4 including, in order from uphole to downhole:
PDM and transmission 5;
Measurement-while-drilling (MWD) package 6;
Receiver module 50;
Pulser assembly 40;
Shock Reduction Tool (SRT) and Universal Bottom Hole Orientation (UBHO) sub 60;
Transmitter module 80; and
Rotary Steerable System (RSS) 90.

FIG. 1B is a block drawing further illustrating schematically the prior art wireless short hop arrangement of FIG. 1A, including a conventional wireless short hop assembly 10 providing a discrete receiver module 50 and pulser assembly 40 (wherein receiver antenna 53 within receiver module 50 is also discrete from pulser assembly 40). FIG. 1B illustrates conventional wireless short hop assembly 10 including an uphole portion 15 and a downhole portion 16. Uphole portion 15 on FIG. 1B provides receiver module 50 at an uphole end thereof. Receiver module 50 is served at an uphole end by snubber connection and wiring harness 20 characterized for receiver module 50. A downhole end of receiver module 50 is connected to a discrete pulser assembly 40 via a snubber connection and wiring harness 30 characterized for pulser assembly 40. In various embodiments, snubber connection and wiring harness 30 for pulser assembly 40 may include one or more physical snubber connections. A downhole end of pulser assembly 40 is connected to SRT and UBHO sub 60.

Receiver module 50 on FIG. 1B includes receiver board 52 positioned uphole of receiver antenna 53. Pulser assembly 40 on FIG. 1B includes pulser board 42 positioned uphole of pulser mechanicals 43. Receiver module 50 on FIG. 1B is discrete from pulser assembly 40, and receiver antenna 53 within receiver module 50 is also discrete from pulser assembly 40. The embodiments of receiver module 50 and pulser assembly 40 shown on FIG. 1B further provide discrete receiver and pulser housings 51, 41, and discrete wiring harnesses characterized for each delivered by discrete snubber connections 20, 30.

Downhole portion 16 of conventional wireless short hop assembly 10 on FIG. 1B provides RSS mount 70 at an uphole end thereof. RSS mount 70 is connected at a downhole end to transmitter module 80. Transmitter module 80 is connected at a downhole end to RSS 90. Transmitter module 80 on FIG. 1B includes transmitter antenna 82 positioned uphole of transmitter board 83. Transmitter module 80 provides transmitter housing 81.

FIG. 1B further illustrates X, a distance between the closest points of receiver antenna 53 and transmitter antenna 82. The distance X is a nominal minimum distance over which conventional wireless short hop assembly 10 on FIG. 1B will have to transmit a wireless signal.

FIG. 1C is a block drawing illustrating schematically an embodiment of BHA components consistent with improvements described in this disclosure, including an improved wireless short hop assembly 100 providing an integrated receiver/pulser module 150. FIG. 1C illustrates improved wireless short hop assembly 100 including an uphole portion 115 and a downhole portion 116.

Uphole portion 115 on FIG. 1C provides integrated receiver/pulser module 150 at an uphole end thereof. The embodiment of integrated receiver/pulser module 150 shown on FIG. 1C includes a unitary receiver/pulser module housing 151 for the receiver and pulser components deployed therein, although the scope of this disclosure is not limited to such unitary housing embodiments. Integrated receiver/pulser module 150 is served at an uphole end by a customized snubber and electrical connection 130 delivering a shared wiring harness serving both the receiver and pulser components inside the unitary receiver/pulser module housing 151. A downhole end of integrated receiver/pulser module 150 is connected to SRT and UBHO sub 60.

Integrated receiver/pulser module 150 on FIG. 1C includes the following components deployed therein, positioned uphole to downhole: receiver board 152, receiver antenna 153, pulser board 142 and pulser mechanicals 143.

Downhole portion 116 of improved wireless short hop assembly 100 on FIG. 1C provides RSS mount 70 at an uphole end thereof. RSS mount 70 is connected at a downhole end to transmitter module 180. Transmitter module 180 is connected at a downhole end to RSS 90. Transmitter module 180 on FIG. 1C includes transmitter antenna 182 positioned uphole of transmitter board 183. Transmitter module 180 provides transmitter housing 181.

FIG. 1C further illustrates Y, a distance between the closest points of receiver antenna 153 and transmitter antenna 182. The distance Y is a nominal minimum distance over which improved wireless short hop assembly 100 on FIG. 1C will have to transmit a wireless signal.

It will be seen from comparison of FIGS. 1B and 1C that by consolidating receiver antenna 53 and pulser assembly 40 on FIG. 1B into integrated receiver/pulser module 150 on FIG. 1C, receiver/pulser module 150 on FIG. 1C positions receiver antenna 153 closer to transmitter antenna 182 than if receiver antenna 53 and pulser assembly 40 are discrete, as in the prior art on FIG. 1B. That is, comparison of FIGS. 1B and 1C shows that distance X is greater than distance Y. The shorter distance Y on FIG. 1C arises from at least the following factors: (a) consolidation of receiver module 50 on FIG. 1B and pulser assembly 40 on FIG. 1B into an integrated receiver/pulser module 150 on FIG. 1C, and (b) obviation and removal on FIG. 1C of snubber connection 30 on FIG. 1B between receiver module 50 and pulser assembly 40. A shorter distance Y for the wireless signal to travel is predictive to increase the signal to noise ratio (SNR) in a transmission in improved wireless short hop assembly 100 on FIG. 1C over the expected SNR in a corresponding transmission in conventional wireless short hop assembly 10 on FIG. 1B. Increased SNR is predictive to improve the quality and stability of the data transmission offered by improved wireless short hop assembly 100 over conventional wireless short hop 10.

Note that FIGS. 1B and 1C are not to scale. In some embodiments, distance X may be about 13.9 feet and distance Y may be about 9.0 feet, although the scope of this disclosure is not limited to particular values of the distances X and Y. As a result, the consolidation offered by improved wireless short hop assembly 100 over conventional wireless short hop assembly 10 reduces the distance between the receiver antenna and the transmitter antenna in some embodiments by at least about 4.4 feet, although this reduction in distance is by way of example only and the scope of this disclosure is not limited in this regard. Further, in such embodiments, consolidation of receiver antenna 53 and pulser assembly 40 on FIG. 1B into integrated receiver/pulser module 150 on FIG. 1C contributed about 2.4 feet (and more precisely, 2.37 feet in some embodiments) to at least about 4.4 feet reduction in transmission distance overall.

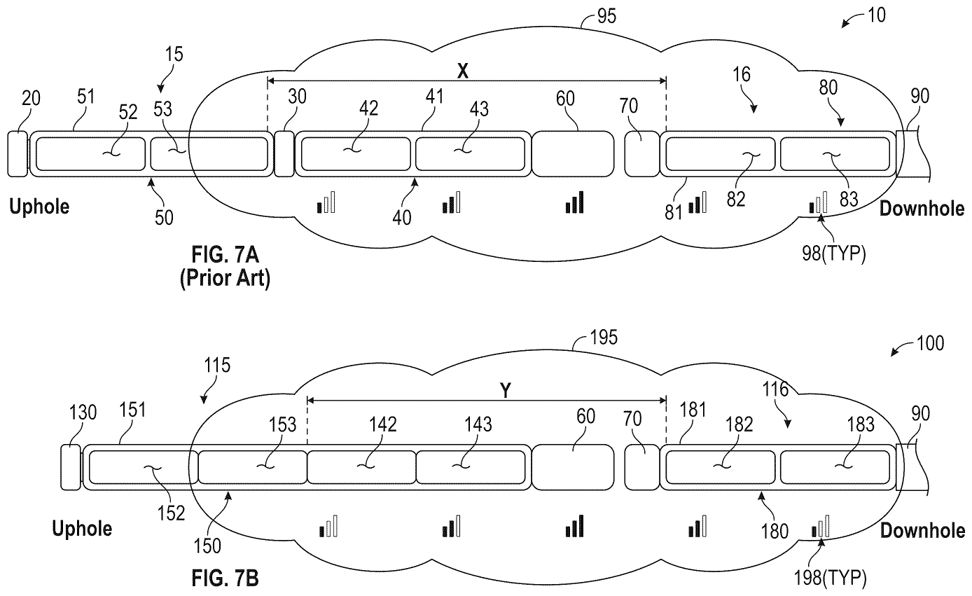

It will also be seen from comparison of FIGS. 1B and 1C that by consolidating receiver antenna 53 and pulser assembly 40 on FIG. 1B into integrated receiver/pulser module 150 on FIG. 1C, receiver/pulser module 150 on FIG. 1C positions receiver antenna 153 closer to shock reduction tool 60 than if receiver antenna 53 and pulser assembly 40 are discrete, as in the prior art on FIG. 1B. As a result, improved wireless short hop assembly 100 on FIG. 1C positions receiver antenna 153 more within the stabilizing field provided by shock reduction tool 60. Refer to the description below of FIGS. 7A and 7B.

It will be further understood from FIG. 1C that although not illustrated, other embodiments of wireless short hop assembly 100 may be deployed without an RSS. Such embodiments may provide a yet shorter distance Y between transmitter antenna 182 and receiver antenna 153 since there will be no RSS mount 70 present. In some embodiments, the distance Y on FIG. 1C may be 6 inches shorter without RSS mount 70, although the scope of this disclosure is not limited in this regard.

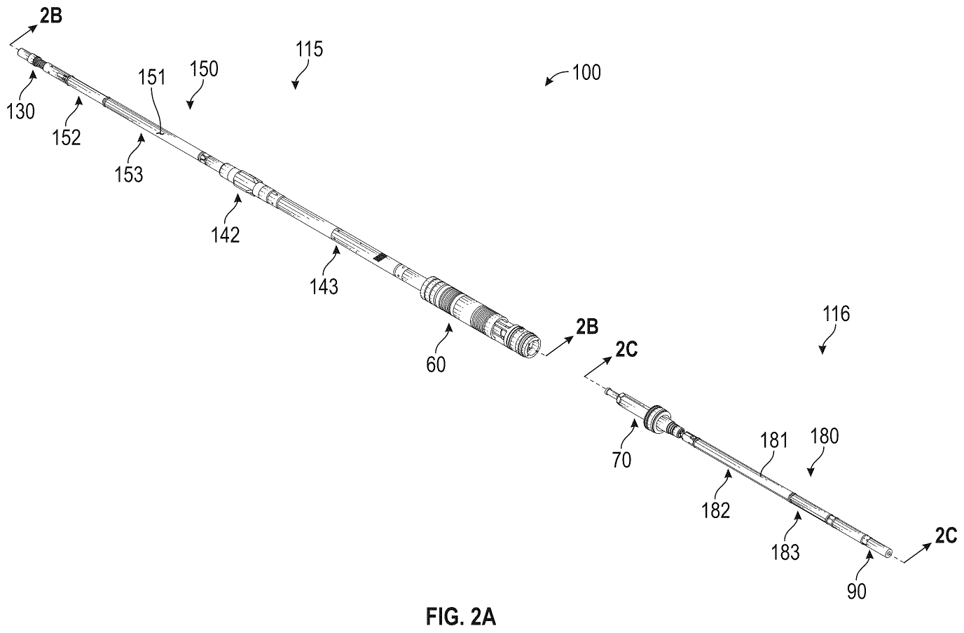

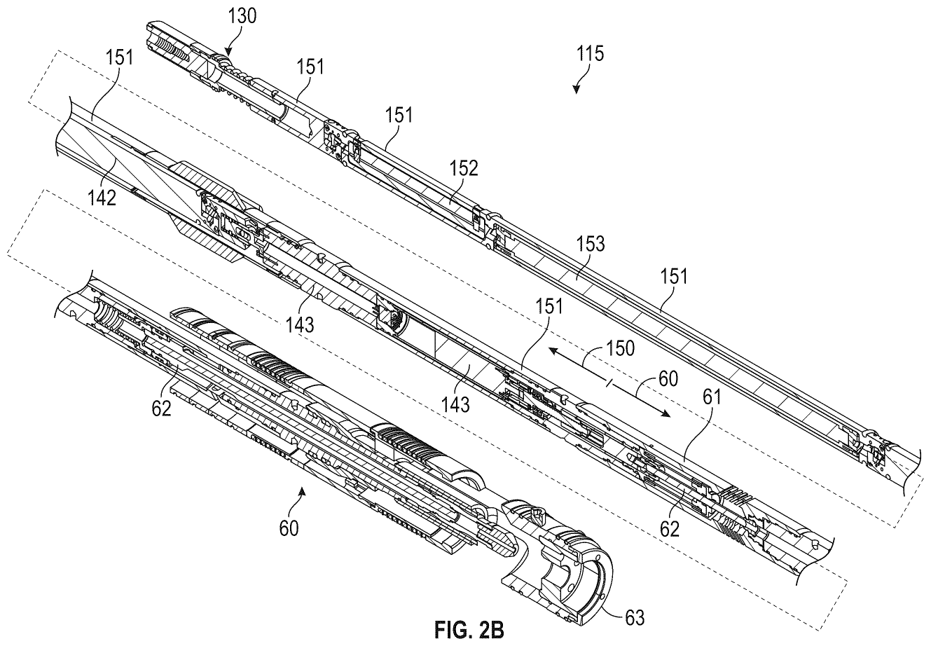

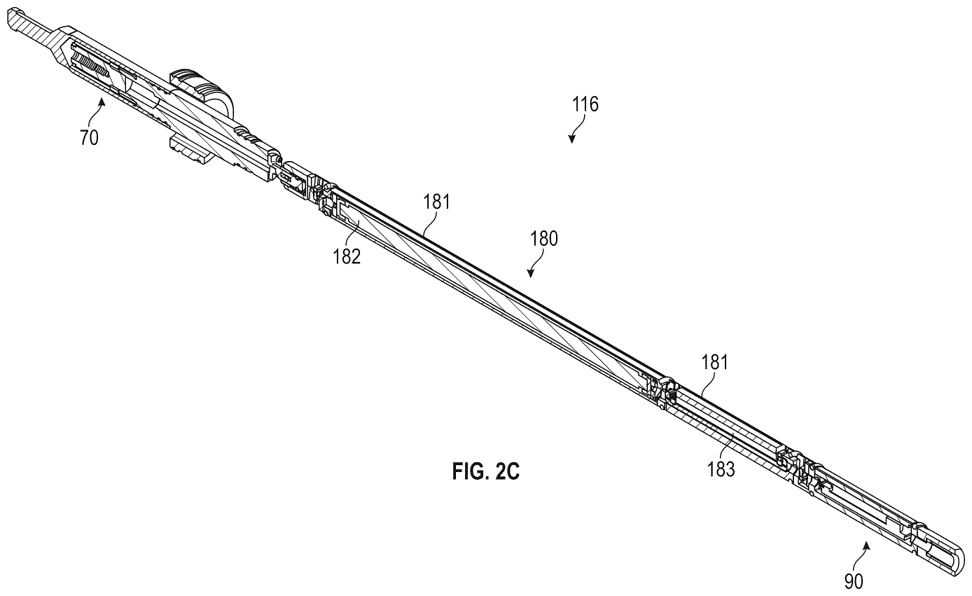

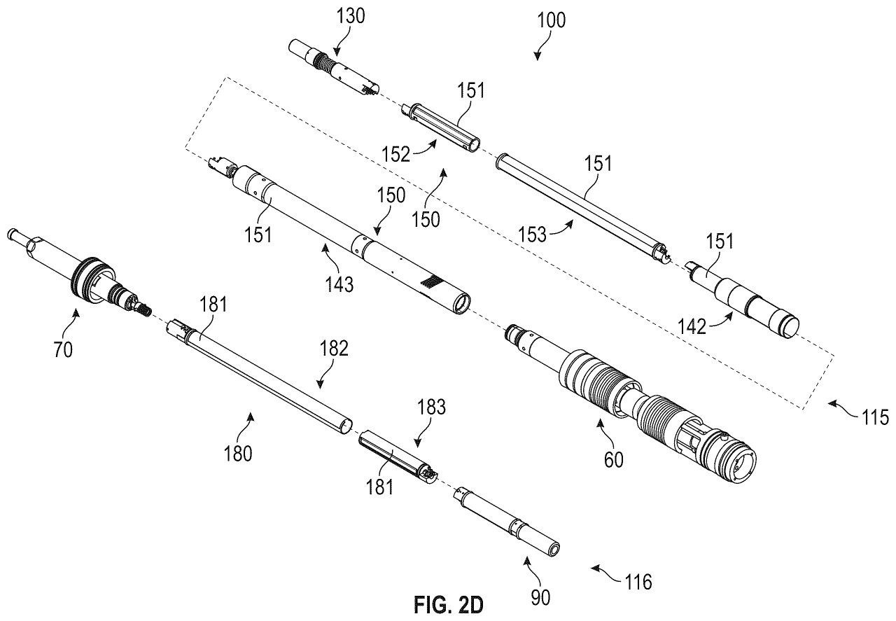

FIGS. 2A through 2D illustrate one embodiment of an improved wireless short hop assembly 100 consistent with the schematic illustration of FIG. 1C. FIG. 2A is a perspective view of an embodiment of improved wireless short hop assembly 100 consistent with the schematic illustration of FIG. 1C. FIG. 2B is a section of uphole portion 115 as shown on FIG. 2A. FIG. 2C is a section of downhole portion 116 as shown on FIG. 2A. FIG. 2D is an exploded view of the embodiment of improved wireless short hop assembly 100 depicted on FIG. 2A.

A description of FIGS. 2A through 2D tracks the description above of FIG. 1C. With general reference to FIGS. 2A through 2D, uphole portion 115 provides integrated receiver/pulser module 150 at an uphole end thereof. Integrated receiver/pulser module 150 includes a unitary receiver/pulser module housing 151 for the receiver and pulser components deployed therein. Integrated receiver/pulser module 150 is served at an uphole end by a customized snubber and electrical connection 130 delivering a shared wiring harness. The shared wiring harness serves both the receiver and pulser components inside the unitary receiver/pulser module housing 151. A downhole end of integrated receiver/pulser module 150 is connected to SRT and UBHO sub 60. The section view on FIG. 2B further depicts SRT and UBHO sub 60 including UBHO assembly 61 and Shock Reduction Tool (“SRT”) 62.

Integrated receiver/pulser module 150 on FIGS. 2A through 2D includes the following components deployed therein, positioned uphole to downhole: receiver board 152, receiver antenna 153, pulser board 142 and pulser mechanicals 143.

Downhole portion 116 of improved wireless short hop assembly 100 on FIGS. 2A through 2D provides RSS mount 70 at an uphole end thereof. RSS mount 70 is connected at a downhole end to transmitter module 180. Transmitter module 180 is connected at a downhole end to RSS 90. Transmitter module 180 includes transmitter antenna 182 positioned uphole of transmitter board 183. Transmitter module 180 provides transmitter housing 181.

Three further points stand out with respect to the embodiments of integrated receiver/pulser module 150 illustrated on FIGS. 2A through 2D. First, snubber connection and electrical connection 130, receiver board 152, receiver antenna 153, pulser board 142, and pulser mechanicals 143 are all shown on FIGS. 2A through 2D within unitary housing 151 on integrated receiver/pulser module 150. Second, there are no snubber/electrical connections on FIGS. 2A through 2D between receiver components (i.e., receiver board 152, receiver antenna 153) and pulser components (i.e., pulser board 142, pulser mechanicals 143). Third, the receiver components (i.e., receiver board 152, receiver antenna 153) and the pulser components (i.e., pulser board 142, pulser mechanicals 143) are disposed to be served electrically by a shared (or common) wiring harness delivered by snubber connection and electrical connection 130.

### Improved Transmission Stability Demonstrated by a Field Deployment of an Embodiment of Integrated Receiver/Pulser 150

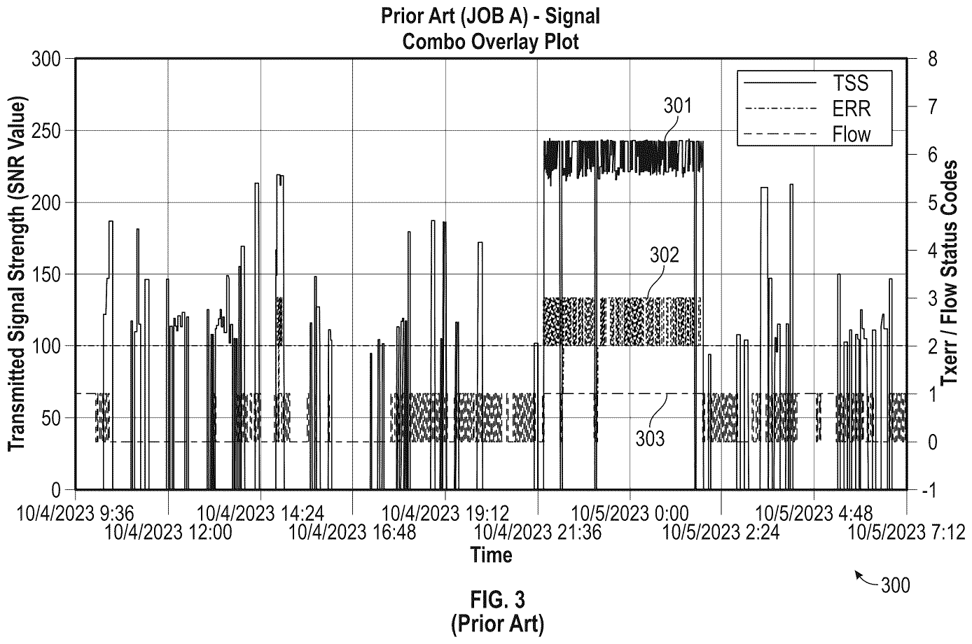

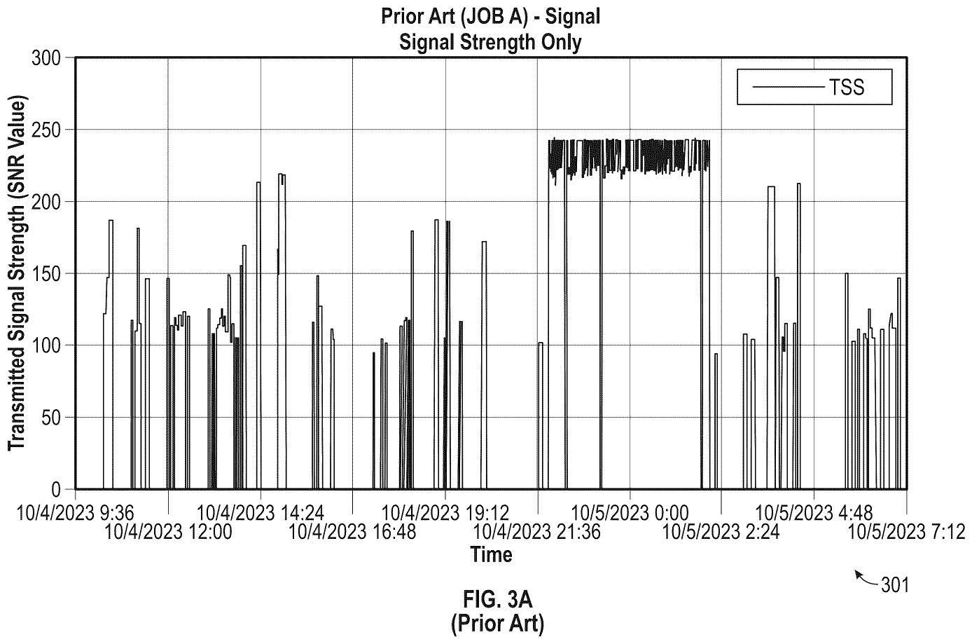

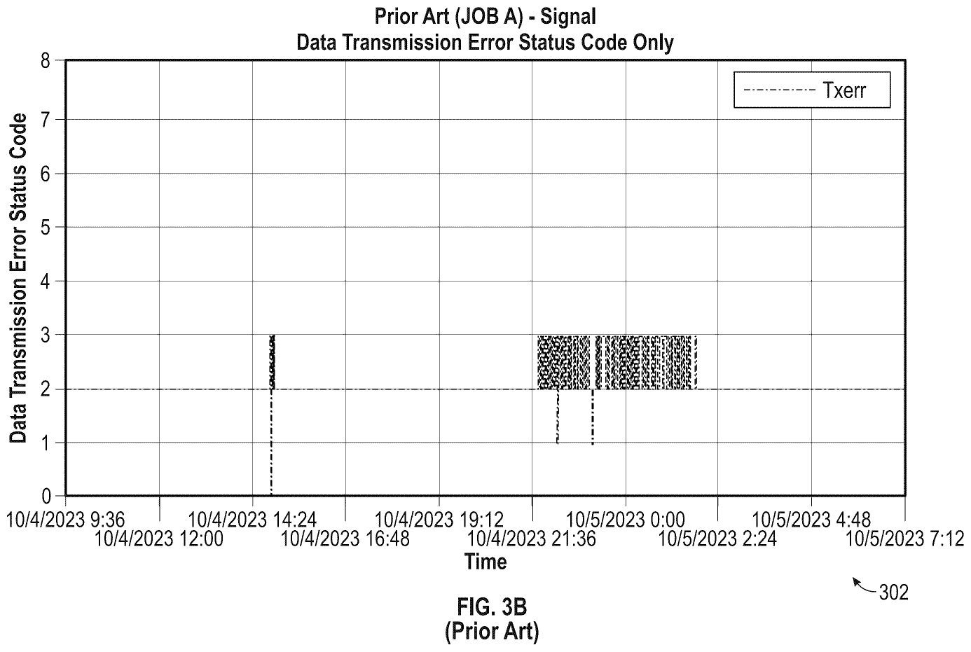

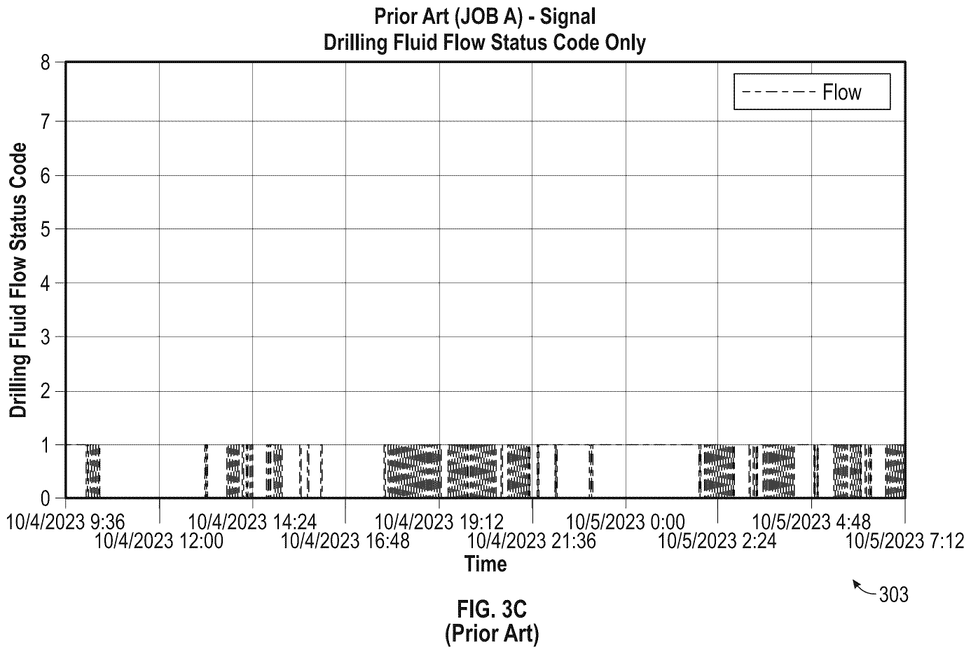

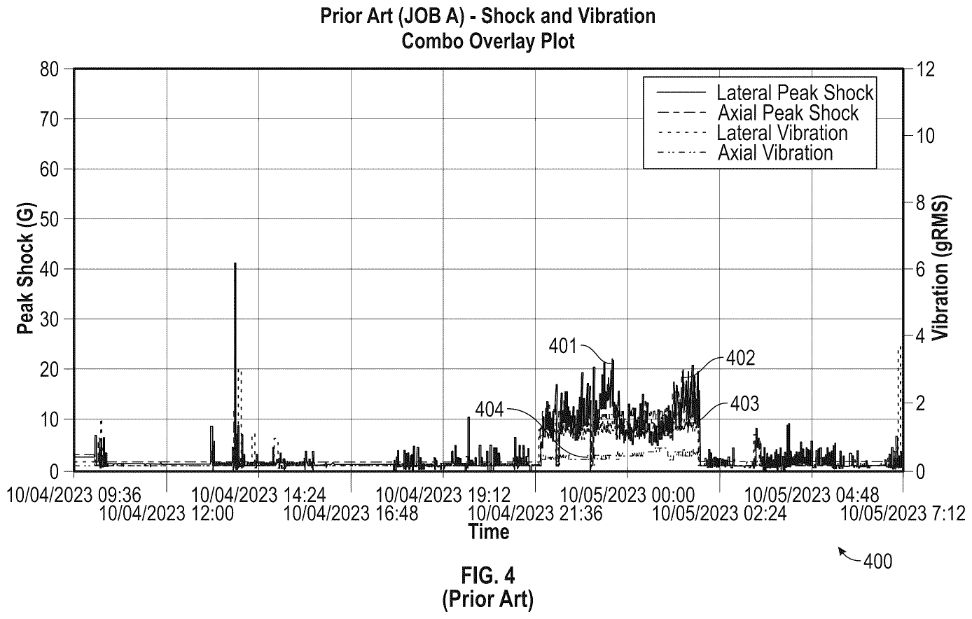

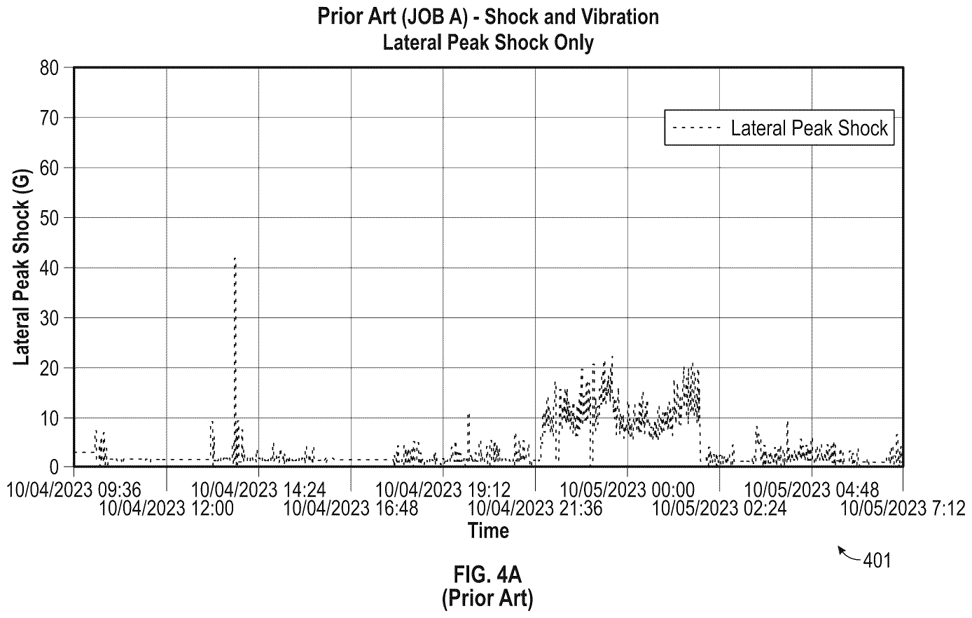

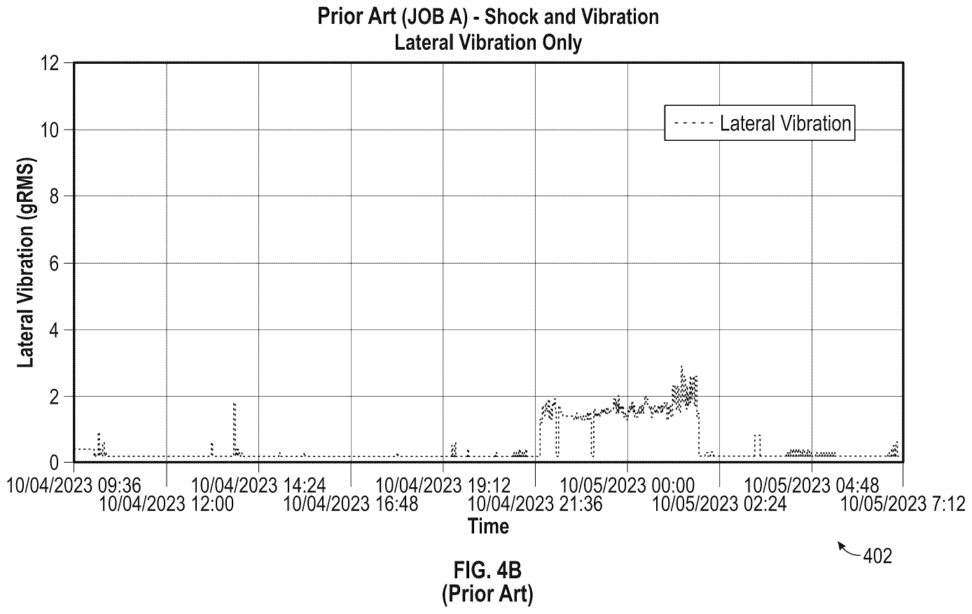

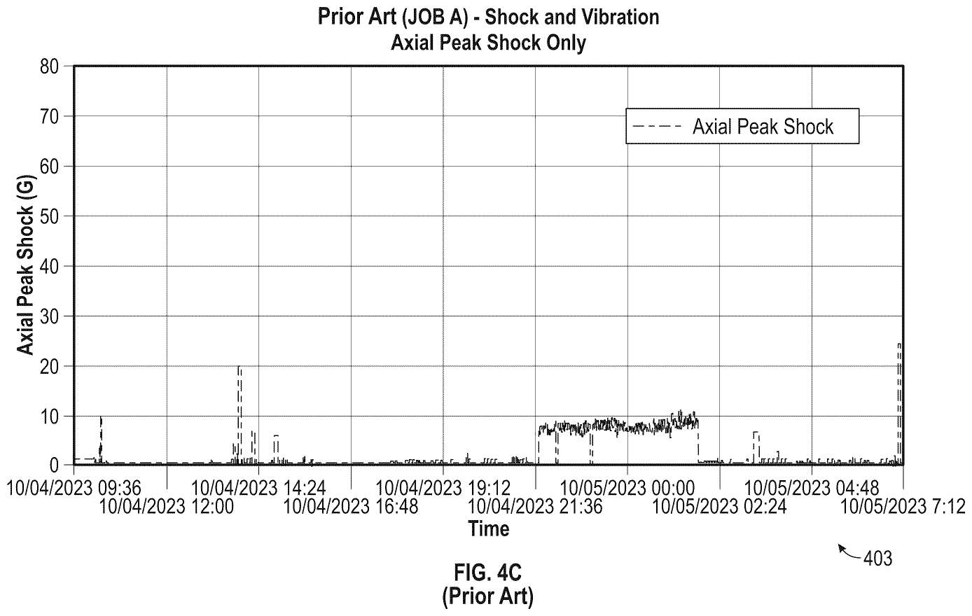

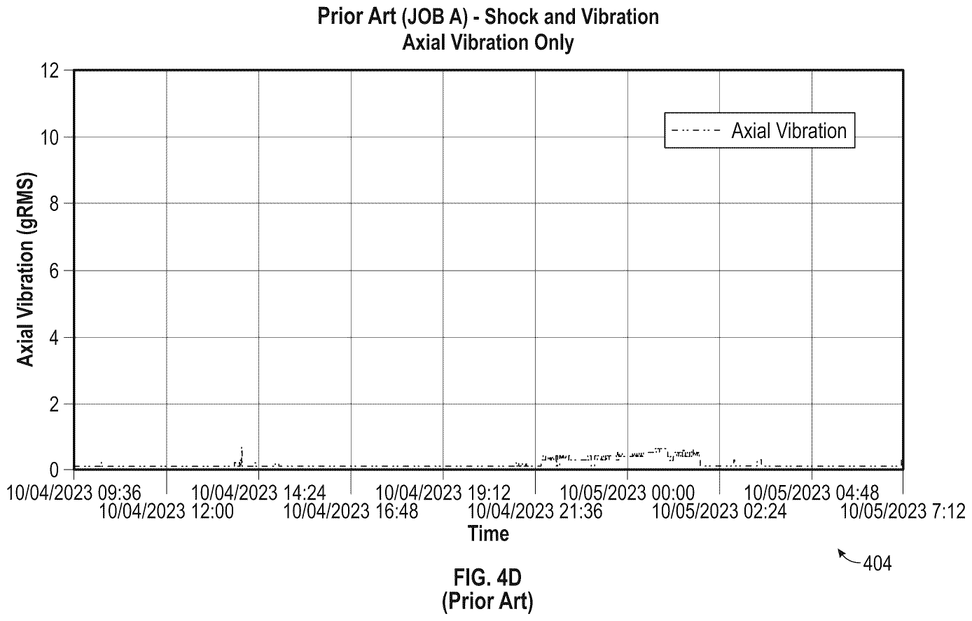

FIGS. 3 through 4D plot data measured during a first drilling job (“JOB A”). A conventional wireless short hop assembly was deployed on JOB A in which the receiver module and the pulser assembly were deployed as discrete, concatenated assemblies in the style of receiver module 50 and pulser assembly 40 on conventional wireless short hop assembly 10 on FIGS. 1A and 1B.

The reader's understanding of FIGS. 3 through 4D may benefit from further reference to color versions of FIGS. 3 through 4D. The color versions may be found as part of the record of U.S. Provisional Patent Application Ser. No. 63/726,518, on which this disclosure relies for priority.

FIGS. 3, 3A, 3B and 3C are graphs plotting values measured for transmitted signal parameters on JOB A in which: FIG. 3 is a combination overlay plot 300 of FIGS. 3A, 3B and 3C; FIG. 3A plots transmitted signal strength 301 by itself over time; FIG. 3B plots data transmission error status code 302 by itself over time; and FIG. 3C plots drilling fluid flow status code 303 by itself over time.

FIGS. 4, 4A, 4B, 4C and 4D are graphs plotting values measured for shock and vibration parameters on JOB A in which: FIG. 4 is a combination overlay plot 400 of FIGS. 4A, 4B, 4C and 4D; FIG. 4A plots lateral peak shock 401 by itself over time; FIG. 4B plots lateral vibration 402 by itself over time; FIG. 4C plots axial peak shock 403 by itself over time; and FIG. 4D plots axial vibration 404 by itself over time.

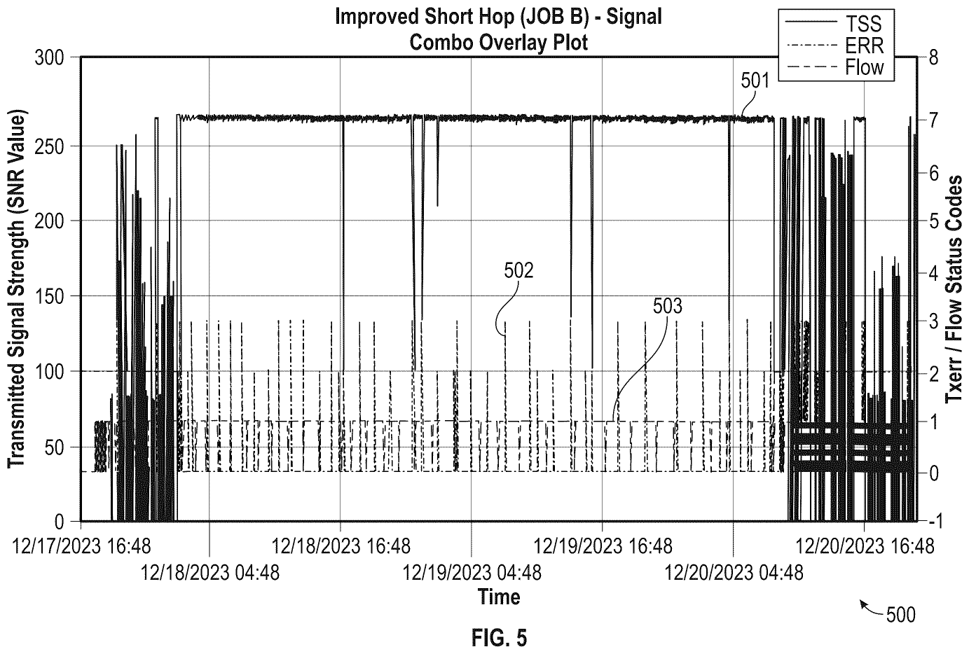

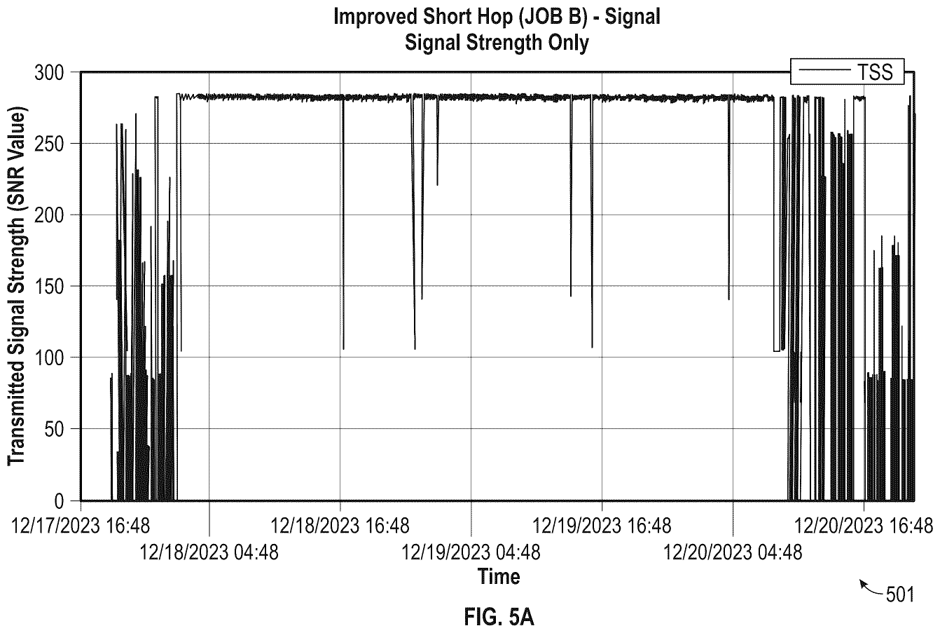

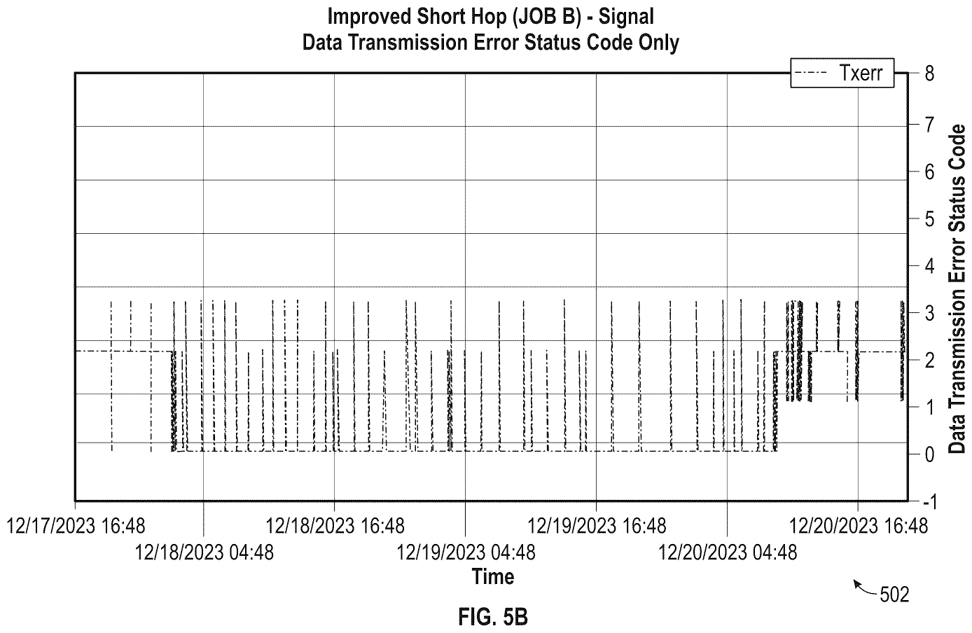

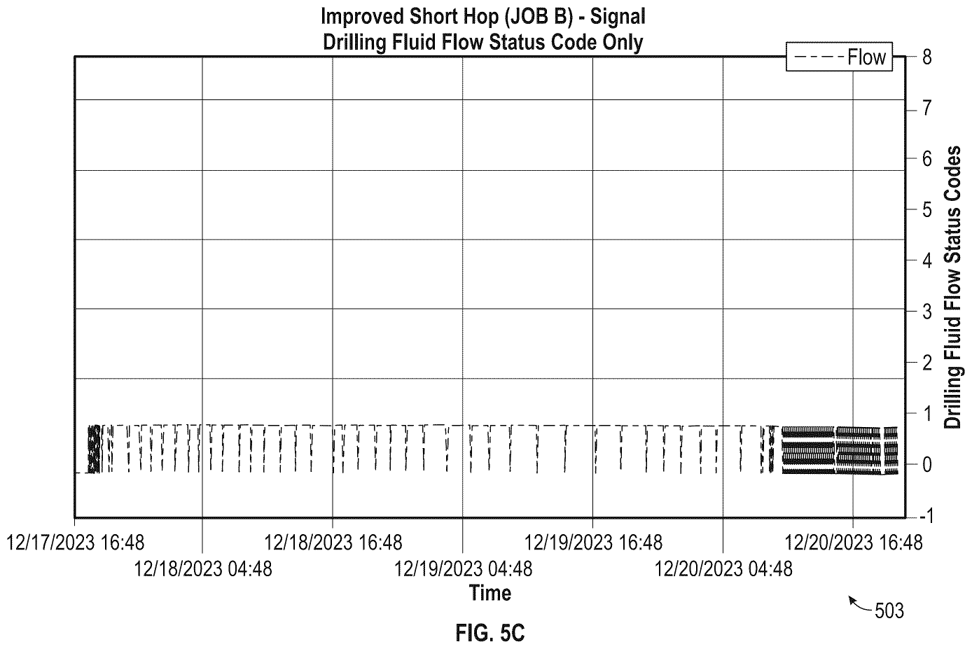

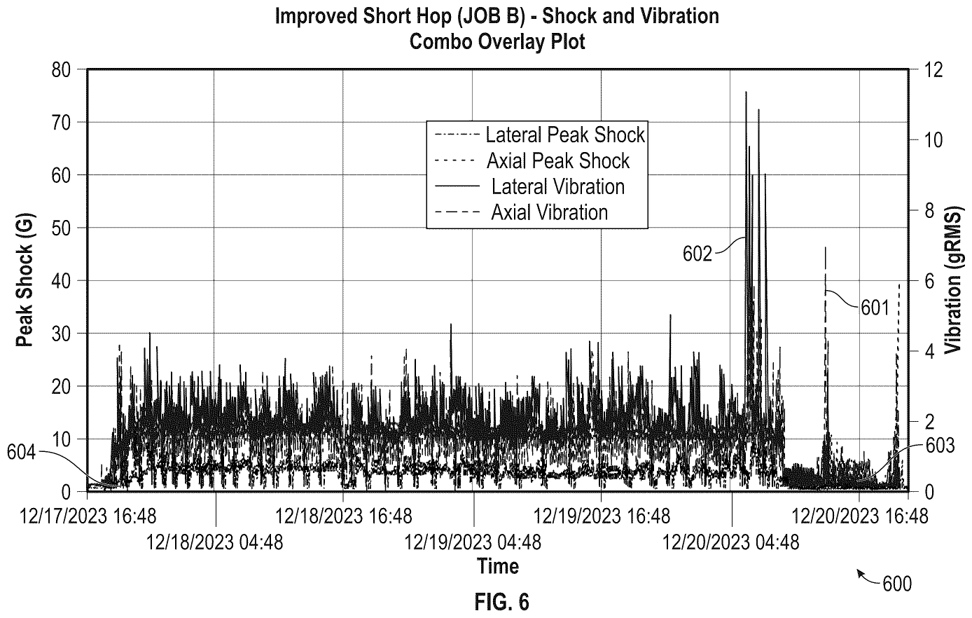

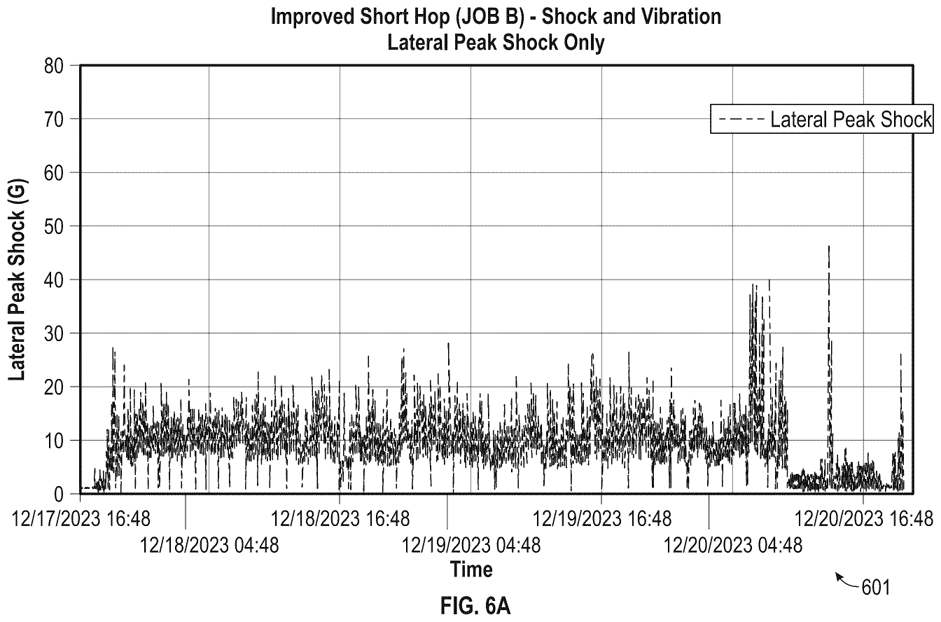

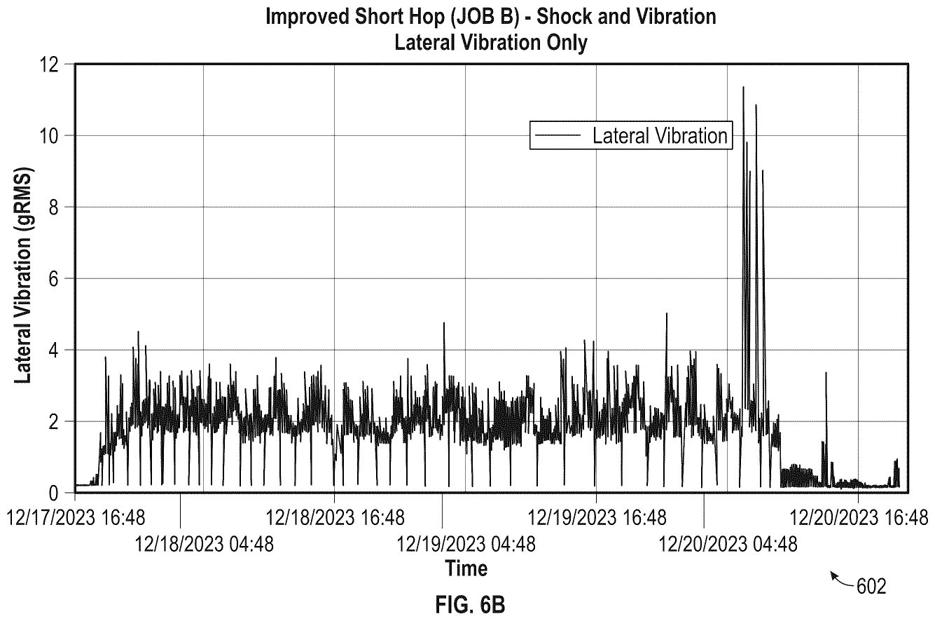

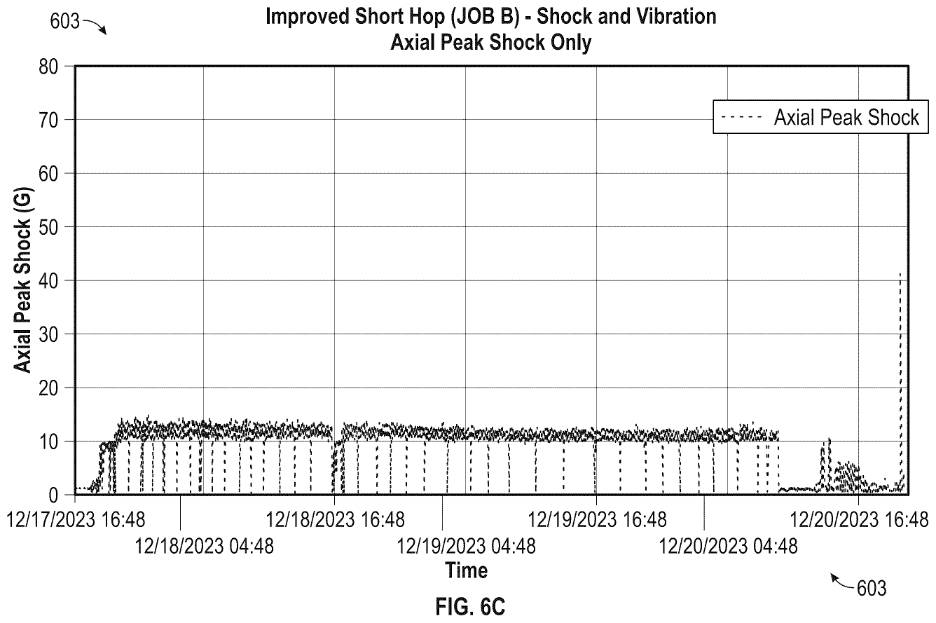

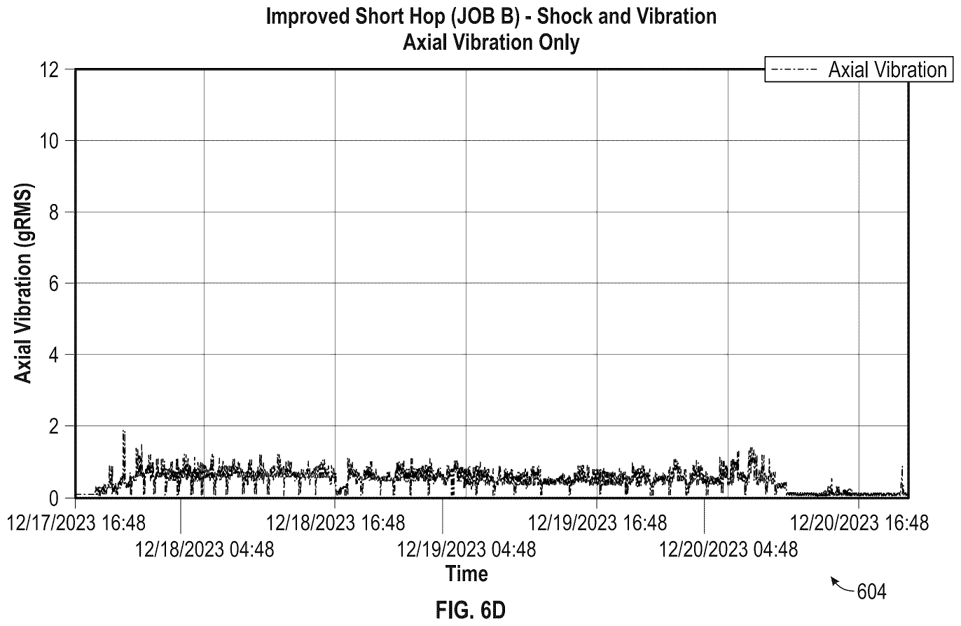

FIGS. 5 through 6D plot data measured during a second drilling job (“JOB B”). JOB B came after JOB A had been completed, and after wireless short hop data from JOB A (such as depicted on FIGS. 3 through 4D) could be captured and assessed for improvement. An improved wireless short hop assembly according to aspects of this disclosure was deployed on JOB B. The improved wireless short hop assembly on JOB B included a receiver/pulser module in the style of integrated receiver/pulser module 150 on FIGS. 1C and 2A through 2D. The improved wireless short hop assembly on JOB B demonstrated superior transmission stability in comparison with corresponding results from JOB A.

The reader's understanding of FIGS. 5 through 6D may benefit from further reference to color versions of FIGS. 5 through 6D. The color versions may be found as part of the record of U.S. Provisional Patent Application Ser. No. 63/726,518, on which this disclosure relies for priority.

FIGS. 5, 5A, 5B and 5C are graphs plotting values measured for transmitted signal parameters on JOB B in which: FIG. 5 is a combination overlay plot 500 of FIGS. 5A, 5B and 5C; FIG. 5A plots transmitted signal strength 501 by itself over time; FIG. 5B plots data transmission error status code 502 by itself over time; and FIG. 5C plots drilling fluid flow status code 503 by itself over time.

FIGS. 6, 6A, 6B, 6C and 6D are graphs plotting values measured for shock and vibration parameters on JOB B in which: FIG. 6 is a combination overlay plot 600 of FIGS. 6A, 6B, 6C and 6D; FIG. 6A plots lateral peak shock 601 by itself over time; FIG. 6B plots lateral vibration 602 by itself over time; FIG. 6C plots axial peak shock 603 by itself over time; and FIG. 6D plots axial vibration 604 by itself over time.

Referring first to JOB A on FIGS. 3A through 4D, it should be noted that the conventional wireless short hop assembly was active and available for transmission data acquisition for only a portion of JOB A. FIG. 3C plots drilling fluid flow status code, in which “1” means drilling fluid is flowing, and “0” means drilling fluid is stopped. Operational drilling will only occur when drilling fluid is flowing. Fluid flow status plot 303 on FIG. 303 shows that sustained drilling was progressing for a period on Oct. 5, 2023 only. Refer also to transmission plot 301 on FIGS. 3 and 3A, in which there was wireless transmission in the same period only. Transmission plot 301 on FIG. 3A shows that transmitted signal strength in this period has an SNR value of about 230-245.

Data transmission error status code plot 302 on FIG. 3B further shows error codes of mainly “2” and “3” during the JOB A period of sustained drilling on Oct. 5, 2023. There were occasional error codes of “1”. Data transmission error status codes are according to the following:
Code 0 Stable communications, steady stream of uncorrupted data packets received
Code 1 Transmitter not receiving data from RSS
Code 2 Receiver not receiving signal from transmitter
Code 3 Checksum algorithm indicates lost or corrupt data packets in signal

FIGS. 3 through 3C therefore demonstrate that the data transmitted by the conventional wireless short hop assembly on JOB A during the period of sustained drilling on Oct. 5, 2023 lacked consistency and stability. When the receiver was actually receiving signal from the transmitter, the checksum algorithm frequently indicated lost or corrupt data packets in the transmitted signal.

FIGS. 4 through 4D indicate shock and vibration conditions prevailing on JOB A during the period of sustained drilling on Oct. 5, 2023. During this period of sustained drilling: Lateral peak shock 401 on FIG. 4A is about 24 G, lateral vibration 402 on FIG. 4B is about 2 gRMS, axial peak shock 403 on FIG. 4C is about 12 G, and axial vibration 404 on FIG. 4D is about 0.4 gRMS.

The conventional wireless short hop assembly's performance on JOB A was assessed from data including that shown on FIGS. 3 through 4D. It was decided to try an improved wireless short hop assembly on JOB B. A first modification moved the receiver antenna closer to the transmitter antenna for JOB B by consolidating the wireless components, including the receiver antenna, with the pulser assembly into an integrated module in the style of integrated receiver/pulser module 150 described above with reference to FIGS. 1C and 2A through 2D. The modification reduced the distance between the receiver antenna and the transmitter antenna by at least about 4.4 feet, although this reduction in distance is by way of example only and the scope of this disclosure is not limited in this regard. Further, in such embodiments, consolidation of receiver antenna 53 and pulser assembly 40 on FIG. 1B into integrated receiver/pulser module 150 on FIG. 1C contributed about 2.4 feet to the overall 4.4 feet reduction in transmission distance.

Moving the receiver antenna closer to the transmitter antenna also brought the receiver antenna more within the stabilizing field of the shock reduction tool (SRT). Refer to SRT and UBHO sub 60 on FIGS. 1C and 2A through 2D. It was foreseen that moving the receiver antenna more within the SRT's stabilizing field would allow the SRT to stabilize short hop data transmissibility. It was recognized that the SRT has the potential to stabilize a wireless signal because the SRT is configured to denoise waveforms by reducing various types of background noise in the stabilizing field, such as vibration and shock. By reducing vibration and shock, it was foreseen that the SRT will also stabilize magnetic flux in the magnetic auras and fields surrounding the SRT (and specifically in the wireless short hop's magnetic auras and fields around the SRT). It was recognized that stabilized magnetic flux should lead to a more stable and consistent signal transmission with fewer packet losses and corruptions.

SRTs typically operate to dampen vibration and shock in the 25 Hz range and below. The conventional wireless short hop assembly used in JOB A was configured to transmit in a range between about 25 Hz and 40 Hz. It was recognized that adapting the conventional wireless short hop assembly to transmit at a lower frequency (e.g., up to about 25 Hz) might further empower the SRT to provide a more stable magnetic field for the short hop's wireless transmission. It was recognized that the SRT's dampening and quieting effect on shock and vibration should have a consequential effect of reducing wireless signal interference in the SRT's surrounding magnetic field when a wireless signal is broadcasting at a similar frequency to the SRT's dampening frequency. Accordingly, it was decided to reconfigure the improved wireless short hop assembly to be deployed on JOB B to transmit in a range between about 10 Hz and about 25 Hz instead of in a range between about 25 Hz and about 40 Hz.

Referring now to JOB B as described on FIG. 5 though 6D, it will be first noted that drilling fluid flow status plot 503 on FIG. 5C indicates flow code “1” (drilling fluid flowing) for sustained periods between Dec. 17, 2023 and Dec. 20, 2023. Sustained drilling activity on JOB B in this period thus allowed ample data acquisition from the improved wireless short hop assembly deployed on JOB B.

Transmission plot 501 on FIGS. 5 and 5A shows sustained transmitted signal strength in the period of Dec. 18, 2023 to Dec. 20, 2023 with an SNR value of about 268-270. Compared to transmission plot 301 on FIGS. 3 and 3A, transmission plot 501 on FIGS. 5 and 5A demonstrates that transmitted signal strength on JOB B had both a higher and more stable SNR than on JOB A. Peak SNR increased from about 245 on JOB A to about 270 on JOB B. Further, SNR fluctuations decreased from about +/−15 SNR on JOB A to about +/−2 SNR on JOB B. Both of these trends are strong indicators of a more stable data transmission on JOB B using the improved wireless short hop assembly. A higher SNR and a more consistent SNR are both predictive of a more stable data transmission.

Data transmission error status code plot 502 on FIG. 5B confirms a more stable data transmission on JOB B using the improved wireless short hop assembly. Data transmission error status code plot 502 on FIG. 3B shows error codes of mainly “0” during the JOB B period of sustained drilling between Dec. 18, 2023 and Dec. 20, 2023. There were occasional errors codes of “2” and “3”. Error code “0” signifies stable communications between transmitter and receiver, with a steady stream of uncorrupted data packets received. The improved wireless short hop assembly deployed on JOB B showed significant data transmissibility improvement as compared to the data transmission performance of the conventional wireless short hop assembly deployed on JOB A. The improved wireless short hop assembly on JOB B demonstrated a much more stable data transmission.

FIG. 6 though 6D suggest that the stabilizing field generated by the SRT in JOB B was comparable in size and strength to the corresponding stabilizing field generated by the SRT in JOB A. Looking at FIGS. 6 through 6D, background shock and vibration experienced on JOB B was comparable to that seen on JOB A. During the period of sustained JOB B drilling between Dec. 18, 2023 and Dec. 20, 2023: Lateral peak shock 601 on FIG. 6A is about 26 G, lateral vibration 602 on FIG. 6B is about 3.8 gRMS, axial peak shock 603 on FIG. 6C is about 13 G, and axial vibration 404 on FIG. 4D is about 0.4 gRMS. These shock and vibration values are quite similar to the corresponding JOB A shock and vibration measurements taken during the period of sustained JOB A drilling on Oct. 5, 2023: Lateral peak shock 401 on FIG. 4A is about 24 G, lateral vibration 402 on FIG. 4B is about 2 gRMS, axial peak shock 403 on FIG. 4C is about 12 G, and axial vibration 404 on FIG. 4D is about 0.8 gRMS. The SRT on JOB B was therefore working comparably to the SRT on JOB A to generate a stabilizing field available to promote a more stable wireless transmission in the SRT's field of view. Stated slightly differently, shock and vibration were likely not differentiating factors affecting the comparative data transmission stability performances of the conventional wireless short hop assembly on JOB A and the improved wireless short hop assembly on JOB B.

FIG. 7A is a rendition of FIG. 1B showing schematically the influence of SRT stabilizing field 95 on a conventional wireless short hop assembly 10 seen in the prior art. FIG. 7B is provided for direct comparison with FIG. 7A. FIG. 7B is a rendition of FIG. 1C showing schematically the influence of SRT stabilizing field 195 on improved wireless short hop assembly 100.

Looking first at FIG. 7A, shock reduction tool 60 provides SRT stabilizing field 95 on conventional wireless short hop assembly 10. Field strength indicators 98 show SRT stabilizing field 95 gaining strength towards shock reduction tool 60. It will be understood that shock reduction tool 60 is configured to dampen background noise (such as shock and vibration) in SRT stabilizing field 95. As such, shock reduction tool 60 will denoise waveforms traveling in SRT stabilizing field 95. On FIG. 7A and as seen in the prior art, pulser assembly 40 is within SRT stabilizing field 95, but receiver module 50 (and especially receiver antenna 53) is only partially within SRT stabilizing field 95, and then only at the edge of SRT stabilizing field 95 where field strength might be weakest.

Similar to FIG. 7A, FIG. 7B shows shock reduction tool 60 providing SRT stabilizing field 195 on improved wireless short assembly 100. Field strength indicators 198 on FIG. 7B show SRT stabilizing field 195 gaining strength towards shock reduction tool 60. It will be appreciated that SRT stabilizing field 195 on FIG. 7B is comparable in size and strength to SRT stabilizing field 95 on FIG. 7A. Comparing FIG. 7B to FIG. 7A, integrated receiver/pulser module 150 on FIG. 7B has positioned receiver antenna 153 closer to shock reduction tool 60 and transmitter antenna 182 than if receiver antenna 53 and pulser assembly 40 are discrete, as shown on FIG. 7A. Therefore, a wireless signal transmitted by transmitter antenna 182 and received by receiver antenna 153 on FIG. 7B travels a shorter distance than if receiver antenna 53 and pulser assembly 40 are discrete as on FIG. 7A. The wireless signal on FIG. 7B will thus have a higher signal-to-noise ratio than on FIG. 7A. Further, the wireless signal on FIG. 7B travels more within SRT stabilizing field 195 than if receiver antenna 53 and pulser assembly 40 were discrete as on FIG. 7A. In fact, in the example of FIGS. 7A and 7B, receiver antenna 153 on FIG. 7B is fully subsumed into and influenced by SRT stabilizing field 195, whereas receiver antenna 53 on FIG. 7A is only partially influenced by SRT stabilizing field 95. The wireless signal on FIG. 7B will thus be more stable than on FIG. 7A, since shock reduction tool 60 on FIG. 7B will denoise the wireless signal by dampening background shock and vibration more thoroughly. Further, shock reduction tool 60 on FIG. 7B will be more effective than on FIG. 7A to steady receiver antenna 153 against vibrations induced in receiver antenna 153 by background shock and vibration and by pulser mechanicals 143 generating mud pulses.

The scope of the inventive material described in this disclosure is not limited to unidirectional transmissions in an uphole direction from transmitter antenna 182 on FIG. 1C to receiver antenna 153. It will be understood that the improved transmission stability brought about by consolidating receiver antenna 53 and pulser assembly 40 on FIG. 1B into integrated receiver/pulser module 150 on FIG. 1C will be similarly effective on bidirectional transmissions, or on unidirectional transmissions in a downhole direction. Although not illustrated or described in this disclosure in detail, it will be understood that transceiver modules may be substituted for transmitter and receiver modules on FIG. 1B in order to enable comparable transmission stability improvement for bidirectional transmissions. Likewise transmitter and receiver modules on FIG. 1B may be swapped in order to enable comparable transmission stability improvement for unidirectional transmissions in a downhole direction.

Although the inventive material in this disclosure has been described in detail along with some of its technical advantages, it will be understood that various changes, substitutions and alternations may be made to the detailed embodiments without departing from the broader spirit and scope of such inventive material. Claimed embodiments follow.

1-30. (canceled)

31. A wireless short hop assembly, comprising:
a transmitter antenna; and
an integrated receiver/pulser module into which a receiver antenna and a pulser assembly are consolidated;
wherein the transmitter antenna is configured to transmit, via magnetic flux induction, a magnetic carrier wave conveying a wireless signal to the receiver antenna;
wherein, when the wireless short hop assembly is deployed on subterranean drilling bottom hole assembly (BHA) such that a shock reduction tool is interposed on the BHA between the transmitter antenna and the integrated receiver/pulser module, the integrated receiver/pulser module positions the receiver antenna closer to the shock reduction tool and the transmitter antenna than if the receiver antenna and the pulser assembly were discrete.

32. The wireless short hop assembly of claim 31, in which the integrated receiver/pulser module consolidates the receiver antenna and pulser assembly into a unitary receiver/pulser module housing.

33. The wireless short hop assembly of claim 31, in which the integrated receiver/pulser module positions the receiver antenna at least about 2.4 feet closer to the transmitter antenna than if the receiver antenna and the pulser assembly were discrete.

34. The wireless short hop assembly of claim 31, in which the magnetic carrier wave is transmitted on a frequency of up to about 25 Hz.

35. The wireless short hop assembly of claim 31, in which the integrated receiver/pulser module has no snubber connections between the receiver antenna and the pulser assembly.

36. The wireless short hop assembly of claim 31, in which the integrated receiver/pulser module further includes a shared wiring harness serving both the receiver antenna and the pulser assembly.

37. A wireless short hop assembly on a subterranean drilling bottom hole assembly, the wireless short hop assembly comprising:
a transmitter antenna; and
an integrated receiver/pulser module into which a receiver antenna and a pulser assembly are consolidated;
wherein the transmitter antenna is configured to transmit, via magnetic flux induction, a magnetic carrier wave conveying a wireless signal to the receiver antenna;
wherein a shock reduction tool is interposed on the bottom hole assembly between the transmitter antenna and the integrated receiver/pulser module;
wherein the integrated receiver/pulser module positions the receiver antenna closer to the shock reduction tool and the transmitter antenna than if the receiver antenna and the pulser assembly were discrete.

38. The wireless short hop assembly of claim 37, in which the integrated receiver/pulser module consolidates the receiver antenna and pulser assembly into a unitary receiver/pulser module housing.

39. The wireless short hop assembly of claim 37, in which the integrated receiver/pulser module positions the receiver antenna at least about 2.4 feet closer to the transmitter antenna than if the receiver antenna and the pulser assembly were discrete.

40. The wireless short hop assembly of claim 37, in which the magnetic carrier wave is transmitted on a frequency of up to about 25 Hz.

41. The wireless short hop assembly of claim 37, in which the integrated receiver/pulser module has no snubber connections between the receiver antenna and the pulser assembly.

42. The wireless short hop assembly of claim 37, in which the integrated receiver/pulser module further includes a shared wiring harness serving both the receiver antenna and the pulser assembly.

43. A method for stabilizing a wireless transmission in a bottom hole assembly, the method comprising the steps of:
providing a transmitter antenna, a receiver antenna, a pulser assembly and a shock reduction tool on a bottom hole assembly;
interposing the pulser assembly and the shock reduction tool on the bottom hole assembly between the transmitter antenna and the receiver antenna;
consolidating the receiver antenna and the pulser assembly into an integrated receiver/pulser module, such that the integrated receiver/pulser module positions the receiver antenna closer to the transmitter antenna than if the receiver antenna and the pulser assembly were discrete;
transmitting, via magnetic flux induction, a magnetic carrier wave conveying a wireless signal from the transmitter antenna; and
receiving the wireless signal at the receiver antenna, wherein the wireless signal as received by the receiver antenna travels a shorter distance than if the receiver antenna and the pulser assembly were discrete.

44. The method of claim 43, in which the receiver antenna and pulser assembly are consolidated into a unitary receiver/pulser module housing.

45. The method of claim 43, in which the integrated receiver/pulser module positions the receiver antenna at least about 2.4 feet closer to the transmitter antenna than if the receiver antenna and the pulser assembly were discrete.

46. The method of claim 43, in which the magnetic carrier wave is transmitted on a frequency of up to about 25 Hz.

47. The method of claim 43, in which the integrated receiver/pulser module has no snubber connections between the receiver antenna and the pulser assembly.

48. The method of claim 43, in which the integrated receiver/pulser module further includes a shared wiring harness serving both the receiver antenna and the pulser assembly.

49. A method for stabilizing a wireless transmission in a bottom hole assembly, the method comprising the steps of:
providing a transmitter antenna, a receiver antenna, a pulser assembly and a shock reduction tool on a bottom hole assembly;
interposing the pulser assembly and the shock reduction tool on the bottom hole assembly between the transmitter antenna and the receiver antenna;
causing the shock reduction tool to create a stabilizing field, wherein the stabilizing field denoises waveforms traveling through the stabilizing field;
consolidating the receiver antenna and the pulser assembly into an integrated receiver/pulser module, such that the integrated receiver/pulser module positions the receiver antenna closer to the shock reduction tool and the transmitter antenna than if the receiver antenna and the pulser assembly were discrete;
transmitting, via magnetic flux induction, a magnetic carrier wave conveying a wireless signal from the transmitter antenna; and
receiving the wireless signal at the receiver antenna, wherein the wireless signal as received by the receiver antenna travels a shorter distance than if the receiver antenna and the pulser assembly were discrete, wherein further the magnetic carrier wave conveying the wireless signal travels more within the stabilizing field than if the receiver antenna and the pulser assembly were discrete.

50. The method of claim 49, in which the receiver antenna and pulser assembly are consolidated into a unitary receiver/pulser module housing.

51. The method of claim 49, in which the integrated receiver/pulser module positions the receiver antenna at least about 2.4 feet closer to the transmitter antenna than if the receiver antenna and the pulser assembly were discrete.

52. The method of claim 49, in which the magnetic carrier wave is transmitted on a frequency of up to about 25 Hz.

53. The method of claim 49, in which the integrated receiver/pulser module has no snubber connections between the receiver antenna and the pulser assembly.

54. The method of claim 49, in which the integrated receiver/pulser module further includes a shared wiring harness serving both the receiver antenna and the pulser assembly.
